(19) United States
(12) Patent Application Publication
(10) Pub. No.: US 2026/0177962 A1
(43) Pub. Date: Jun. 25, 2026

(54) IMAGE FORMING APPARATUS

(71) Applicant: CANON KABUSHIKI KAISHA, Tokyo (JP)

(72) Inventor: SHUJI OBATA, Chiba (JP)

(21) Appl. No.: 19/421,428

(22) Filed: Dec. 16, 2025

(30) Foreign Application Priority Data
Dec. 24, 2024 (JP) 2024-227526

(51) Int. Cl. G03G 15/00; G03G 21/16

(52) U.S. Cl. CPC G03G 15/502; G03G 21/1647; G03G 2221/1651

(57) ABSTRACT

An image forming apparatus for printing an image on a sheet includes an operation panel which includes a display and which is mounted in a replaceable manner on a main body, wherein the display is configured to display a work procedure for replacement of the operation panel.

### BACKGROUND

### FIELD OF THE TECHNOLOGY

The present disclosure relates to an image forming apparatus having a configuration in which an operation panel is replaceable.

### DESCRIPTION OF THE RELATED ART

An image forming apparatus for forming an image on a recording medium includes an operation panel including a display for displaying a progress status of an image forming operation and screens for setting various conditions. The operation panel (display) tends to be increased in size in accordance with improvement of visibility and an increase in amount of information to be displayed. Further, image forming apparatus of different sizes are prepared to adapt to usage environments, and there is a demand for providing an equivalent operation panel (display) for the image forming apparatus of all sizes. In Japanese Patent Application Laid-open No. 2013-228554, there has been proposed a technology of allowing a plurality of operation panels of different sizes to be mounted in accordance with an installation space of the image forming apparatus.

When the operation panel is to be replaced in the image forming apparatus after being shipped, in a case of a service technician, work is performed while checking a manual or the like. Such a manual is normally displayed on a terminal or the like carried by the service technician. However, when a user replaces the operation panel, the user cannot refer to such a manual. Accordingly, it is difficult for the user to replace the operation panel.

### SUMMARY

An image forming apparatus for printing an image on a sheet according to at least one of the present disclosure includes an operation panel which includes a display and which is mounted in a replaceable manner on a main body, wherein the display is configured to display a work procedure for replacement of the operation panel.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration view of an image forming system.

FIG. 2 is a system configuration diagram of an image forming apparatus.

FIG. 3A, FIG. 3B, and FIG. 3C are explanatory configuration views of an operation panel.

FIG. 4A, FIG. 4B, and FIG. 4C are perspective views for illustrating a state in which the operation panel is mounted on the image forming apparatus.

FIG. 5 is a system configuration diagram of the operation panel.

FIG. 6A, FIG. 6B, FIG. 6C, and FIG. 6D are exemplary views of procedure images of replacement work.

FIG. 7A, FIG. 7B, FIG. 7C, and FIG. 7D are exemplary views of procedure images of the replacement work.

FIG. 8A, FIG. 8B, FIG. 8C, and FIG. 8D are exemplary views of procedure images of the replacement work.

FIG. 9A, FIG. 9B, FIG. 9C, and FIG. 9D are exemplary views of procedure images of the replacement work.

FIG. 10 is a flow chart for illustrating processing of displaying procedure images of work of replacing the operation panel.

FIG. 11A and FIG. 11B are flow charts for illustrating the processing of displaying the procedure images of the work of replacing the operation panel.

FIG. 12 is an explanatory diagram of a power supply state.

FIG. 13 is an explanatory diagram of the power supply state.

FIG. 14 is an explanatory diagram of the power supply state.

### DESCRIPTION OF THE EMBODIMENTS

Now, at least one exemplary embodiment of the present disclosure is described with reference to the attached drawings. However, unless otherwise specifically described, for example, dimensions, materials, shapes, and relative arrangements of components described below are not intended to limit the scope of the present disclosure solely to those described herein.

### <Image Forming Apparatus>

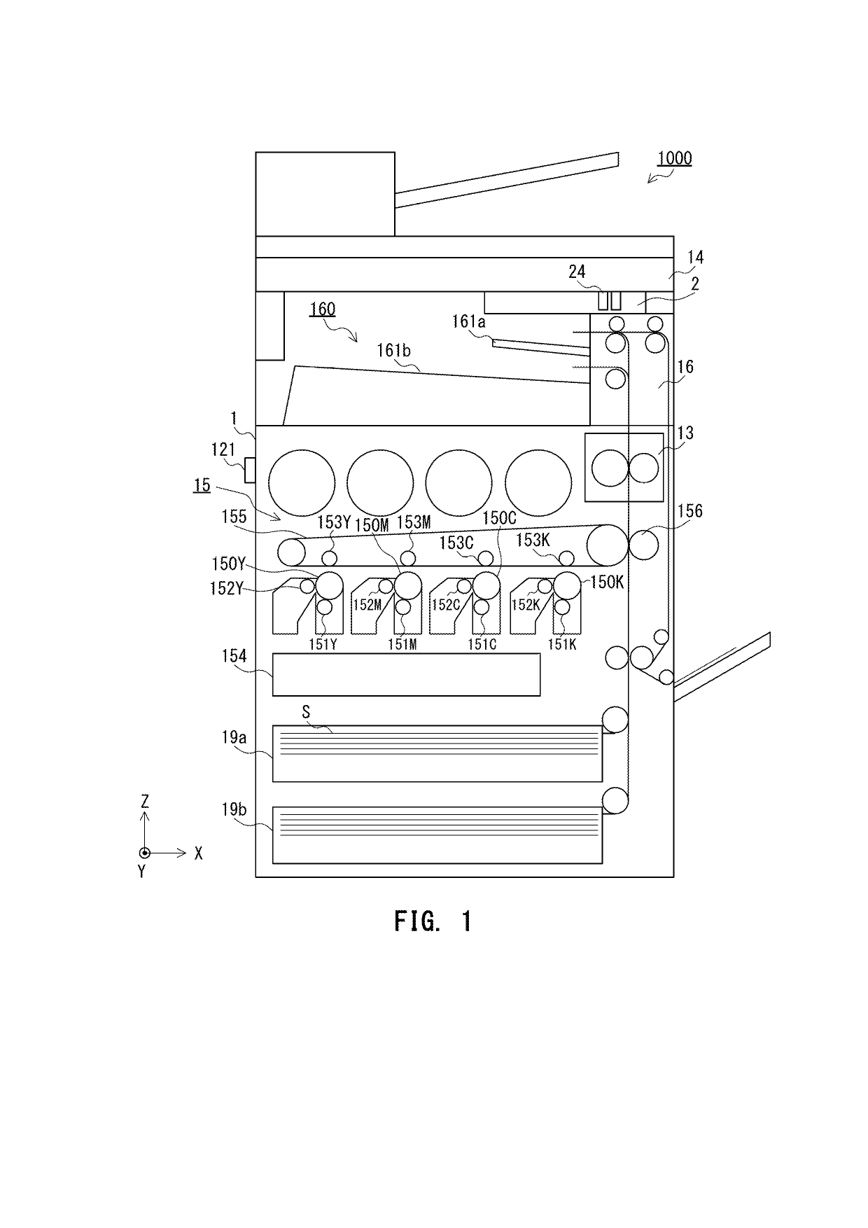

FIG. 1 is a configuration view of an image forming system according to the at least one embodiment of the present disclosure. An image forming system 1000 includes an image forming apparatus 1 for forming an image on a sheet S that is a recording medium, and a reader 14 that is an image reading apparatus. The reader 14 optically reads an image of an original placed on a glass surface (not shown) to convert the read image into image data. The image forming system 1000 can have a processing device 16 added thereto as an option. The processing device 16 performs processing such as stapling processing, punching processing, and bookbinding processing on the sheet S having an image formed thereon by the image forming apparatus 1.

The image forming apparatus 1 includes a main body power switch 121 of a rocker type or a tactile type for switching on/off of a main power supply. The image forming apparatus 1 includes an operation panel 2 as a user interface including an input interface and an output interface. Details of the operation panel 2 are described later, but a user can use the operation panel 2 to perform settings relating to image formation such as settings of the number of sheets to be subjected to image formation and the size of the sheet S, and settings relating to reading of an image such as settings of the size of the original. The operation panel 2 includes a state indicator 24 for notifying the user of the state of the image forming apparatus 1 (a state of being during job execution, or occurrence of an error such as jamming).

The image forming apparatus 1 includes an image forming unit 15 for forming an image on the sheet S. The image forming unit 15 includes photosensitive drums 150Y, 150M, 150C, and 150K, charging devices 151Y, 151M, 151C, and 151K, and developing devices 152Y, 152M, 152C, and 152K. Further, the image forming unit 15 includes primary transfer rollers 153Y, 153M, 153C, and 153K, a laser scanner unit 154, an intermediate transfer belt 155, a secondary transfer roller 156, and the like.

The image forming apparatus 1 includes sheet cassettes 19a and 19b for storing the sheets S. The sheets are fed one by one from any one of the sheet cassettes 19a and 19b, and are conveyed to a secondary transfer portion formed of the intermediate transfer belt 155 and the secondary transfer roller 156.

As an operation of the image forming unit 15, a case in which an image is formed on the photosensitive drum 150Y is described. On the photosensitive drum 150Y, an image of yellow (Y) is formed. The photosensitive drum 150Y is a drum-shaped photosensitive member having a photosensitive layer on its surface. The charging device 151Y uniformly charges the surface of the photosensitive drum 150Y. The laser scanner unit 154 irradiates the uniformly-charged surface of the photosensitive drum 150Y with laser light in accordance with image data of an original read by the reader 14 or image data transmitted from an external apparatus (not shown) via a network. In this manner, an electrostatic latent image corresponding to the image data is formed on the surface of the photosensitive drum 150Y.

The developing device 152Y causes yellow toner to adhere to the electrostatic latent image formed on the surface of the photosensitive drum 150Y, to thereby form a yellow toner image on the surface of the photosensitive drum 150Y. The toner image formed on the surface of the photosensitive drum 150Y is primarily transferred onto the intermediate transfer belt 155 by applying a primary transfer bias to the primary transfer roller 153Y.

With a similar process, a magenta toner image is formed on the photosensitive drum 150M, a cyan toner image is formed on the photosensitive drum 150C, and a black toner image is formed on the photosensitive drum 150K. With a primary transfer bias being applied to the primary transfer rollers 153M, 153C, and 153K, the toner images of the corresponding colors are transferred in superimposition onto the yellow toner image formed on the intermediate transfer belt 155. In this manner, a full-color toner image corresponding to the image data is formed on the surface of the intermediate transfer belt 155. The intermediate transfer belt 155 performs circular movement to convey the full-color toner image borne by the intermediate transfer belt 155 to a secondary transfer portion.

In the secondary transfer portion, a secondary transfer bias is applied to the secondary transfer roller 156 so that the full-color toner image formed on the intermediate transfer belt 155 is transferred onto the sheet S. The sheet S having the toner image transferred thereon is conveyed to a fixing device 13. The fixing device 13 fixes the toner image to the sheet S by performing, for example, heating and pressure application processing.

The sheet S having the toner image fixed thereto is conveyed to the processing device 16. The processing device 16 discharges the sheet S to a sheet discharge region 160. When the user has designated processing such as stapling processing, punching processing, or bookbinding processing, the processing device 16 subjects the sheet S to the designated processing and then discharges the sheet S to a discharge tray 161a. When the user has not designated any processing or when no processing device 16 is provided, the sheet S is discharged from the fixing device 13 to a discharge tray 161b of the sheet discharge region 160.

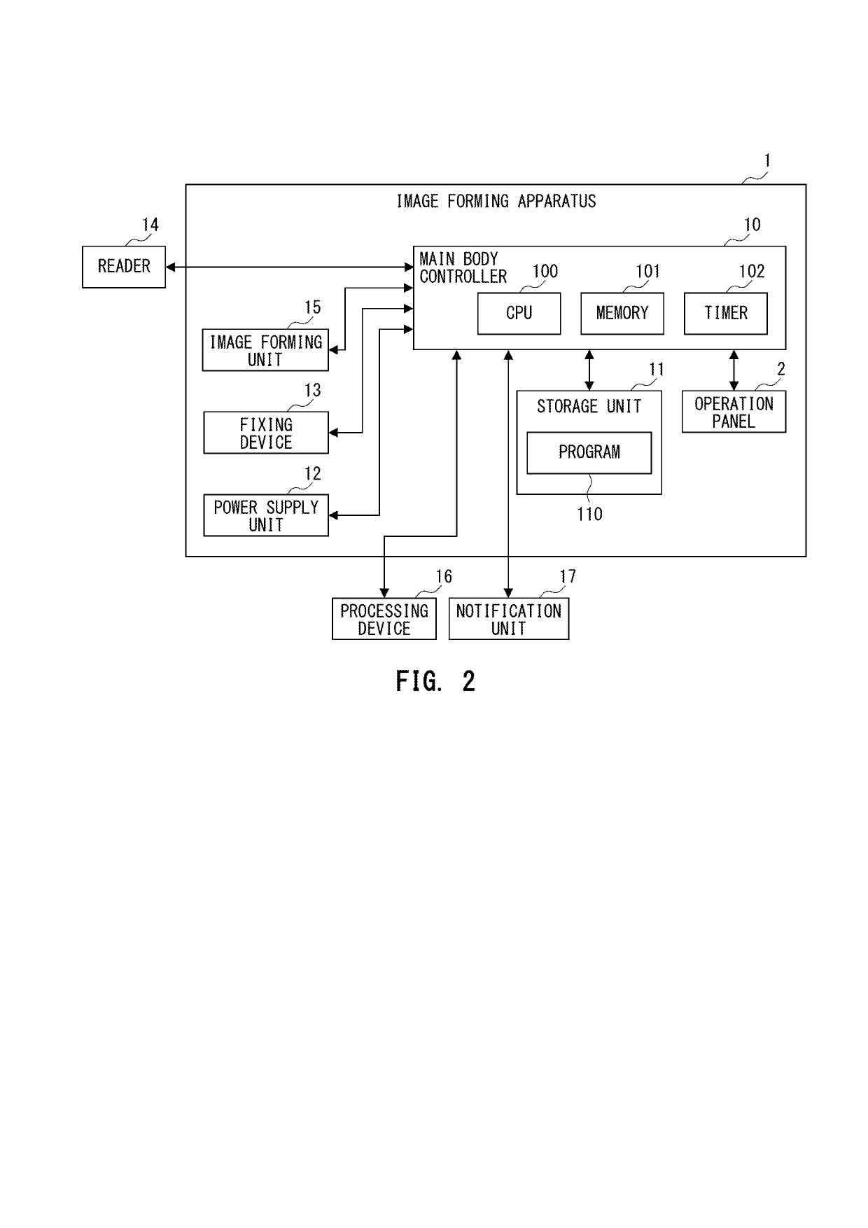

FIG. 2 is a system configuration diagram of the image forming apparatus 1. The image forming apparatus 1 includes a main body controller 10 for controlling the image forming operation as described above. The main body controller 10 is an information processing device including a central processing unit (CPU) 100, a memory 101, and a timer 102. To the main body controller 10, a storage unit 11, a power supply unit 12, the fixing device 13, the reader 14, the image forming unit 15, the operation panel 2, and the like are connected. Further, the processing device 16 that is an option device is connectable to the main body controller 10. Moreover, a notification unit 17 is connected to the main body controller 10. The CPU 100 of the main body controller 10 controls the operation of each unit connected to the main body controller 10.

The storage unit 11 stores various programs 110 relating to control of the image forming apparatus 1 and various display images, pieces of image data, and the like. The various programs 110 stored in the storage unit 11 are a software group used to allow the main body controller 10 to perform various types of processing. The display images stored in the storage unit 11 include, for example, display images (image data) to be displayed on the operation panel 2. Examples of the display images include an image for displaying or printing an image representing a procedure of replacing the operation panel 2 to be described later.

The CPU 100 reads out and executes the program 110 stored in the storage unit 11 to control the operation of the image forming apparatus 1. The CPU 100 reads out the display image (image data) to be displayed on the operation panel 2 from the storage unit 11, and transmits the display image (image data) to the operation panel 2. The operation panel 2 displays the display image corresponding to the image data acquired from the CPU 100. The memory 101 is a main memory used when the CPU 100 executes the program 110, and performs, for example, temporal storage of data.

The CPU 100 executes the program 110 stored in the storage unit 11 through use of the memory 101 as a work area, to thereby control operations of the reader 14, the image forming unit 15, the processing device 16, and the like connected to the main body controller 10. In this manner, for example, processing for forming an image on the sheet S is performed. For example, the CPU 100 controls the reader 14 to generate image data read from an original. The CPU 100 stores the image data generated as described above into the storage unit 11. After that, the CPU 100 transfers the image data stored in the storage unit 11 to the image forming unit 15 to execute the above-mentioned image forming processing.

The timer 102 is used to allow the main body controller 10 to perform counting at the time of performing various types of processing. For example, the main body controller 10 makes a determination to cause the image forming apparatus 1 to shift to a sleep mode having low power consumption from a standby mode, depending on a count value of the timer 102. The power supply unit 12 converts electric power supplied from a commercial power source via an outlet plug into electric power to be used in each device, and supplies the converted electric power. The notification unit 17 is a revolving light or the like, and is provided so that the notification unit 17 can notify even a user separated away from the image forming apparatus 1 of an abnormality when the abnormality has occurred in the image forming apparatus 1.

### <Operation Panel>

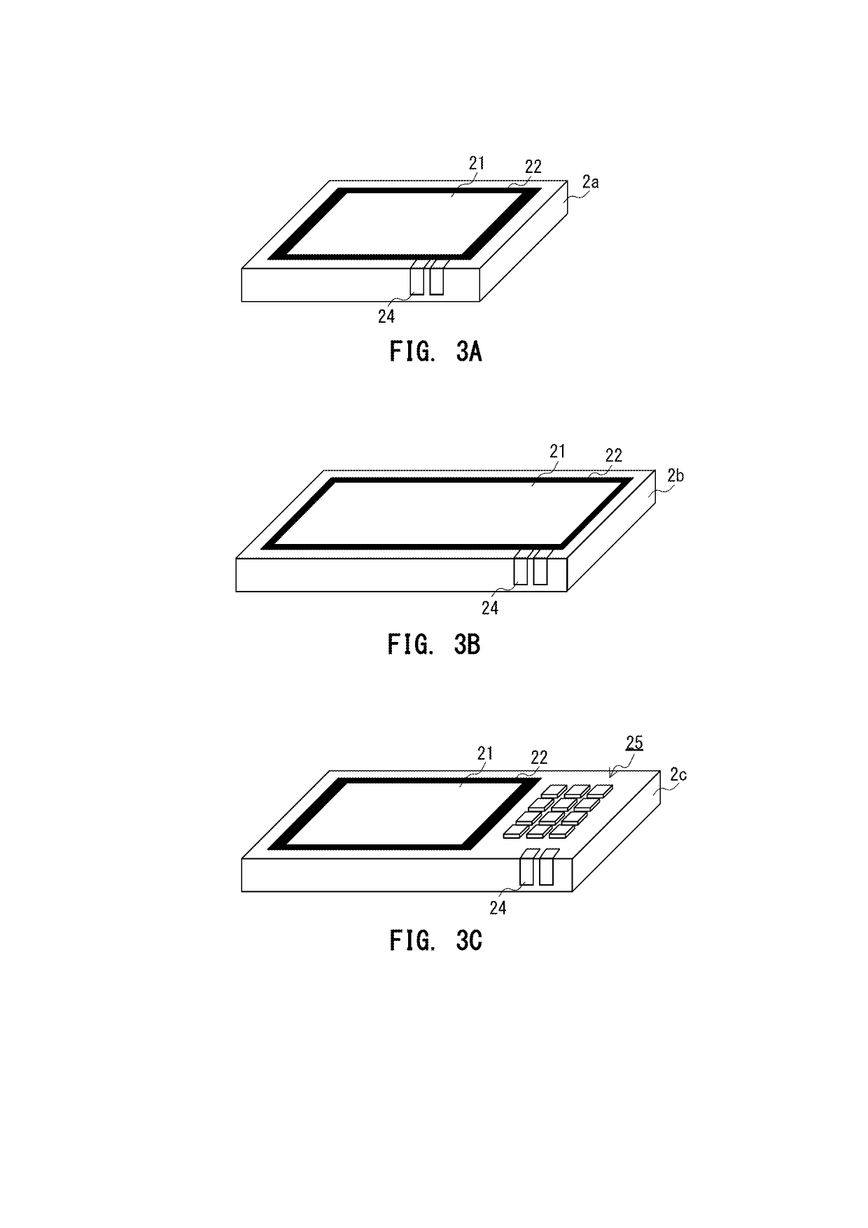

FIG. 3A to FIG. 3C are explanatory configuration views of the operation panel 2. A plurality of types of operation panels 2 are mountable to the image forming apparatus 1. The operation panel 2 in the at least one embodiment is an operation panel 2a of FIG. 3A, an operation panel 2b of FIG. 3B, and an operation panel 2c of FIG. 3C. Those operation panels 2a, 2b, and 2c are mountable to the image forming apparatus 1. The number of operation panels 2 mountable to the image forming apparatus 1 is not limited to three, and may be larger than three, or may conversely be two. In any case, one of a plurality of types of operation panel 2 is mounted in a replaceable manner on the main body of the image forming apparatus 1.

The operation panel 2a of FIG. 3A is described. The operation panel 2a includes a display 21 capable of displaying an image, and a touch panel 22 for receiving a touch operation from the user. The user can perform various settings by operating a software key (input portion or button) displayed on the display 21 with a finger. The display 21 is the output interface, and the touch panel 22 is the input interface.

The display 21 is, for example, a flat panel display such as a liquid crystal panel display or an organic electro-luminescence (EL) display. The touch panel 22 is a transparent member provided to overlap the display 21, and detects an operation performed on the display 21, to thereby receive an operation instruction given by the user. The display 21 displays an image through the touch panel 22. In the at least one embodiment, the display 21 and the touch panel 22 are formed of separate members, but a touch panel display having both functions of the display 21 and the touch panel 22 may be used.

The state indicator 24 of the operation panel 2 indicates that, as described above, the image forming apparatus 1 is during job execution or during error occurrence. The state indicator 24 includes, for example, lighting portions of a plurality of colors such as red and green. The lighting portions are, for example, light-emitting diodes (LEDs). With a color or a lighting pattern of the turned-on lighting portion, the user is notified of the state of the image forming apparatus 1. The state indicator 24 is also an example of the output interface.

The operation panel 2b of FIG. 3B is described. The size of the operation panel 2b is extended as compared to the operation panel 2a, and thus the size of the display 21 is larger than that of the operation panel 2a. With the size of the display being increased, there are advantages in that, for example, the screen is easier to see and easier to operate depending on the user. Further, the operation panel 2a and the operation panel 2b are different in a component for connecting the operation panel 2 to the main body of the image forming apparatus 1. The component for connecting the operation panel 2 to the main body is required to be installed at an appropriate position depending on the size of the operation panel 2.

The operation panel 2c of FIG. 3C is described. In the operation panel 2c, a key operation input unit 25 is additionally provided to the configuration of the operation panel 2a. The key operation input unit 25 is provided to allow the user to perform settings or job instructions of the image forming apparatus 1. The key operation input unit 25 is a hardware key provided in a region other than the display 21 of the operation panel 2. The key operation input unit 25 is also an example of the input interface.

The key operation input unit 25 includes, for example, a start key for starting the job of the image forming apparatus 1, a numeric keypad, and a power saving key for giving an instruction to shift to a power saving mode, and is an operation panel for a user who desires to perform operation through use of a hardware key. Further, similarly to the operation panel 2b, the operation panel 2c is different from the operation panel 2a in the component for connecting the operation panel 2 to the main body of the image forming apparatus 1.

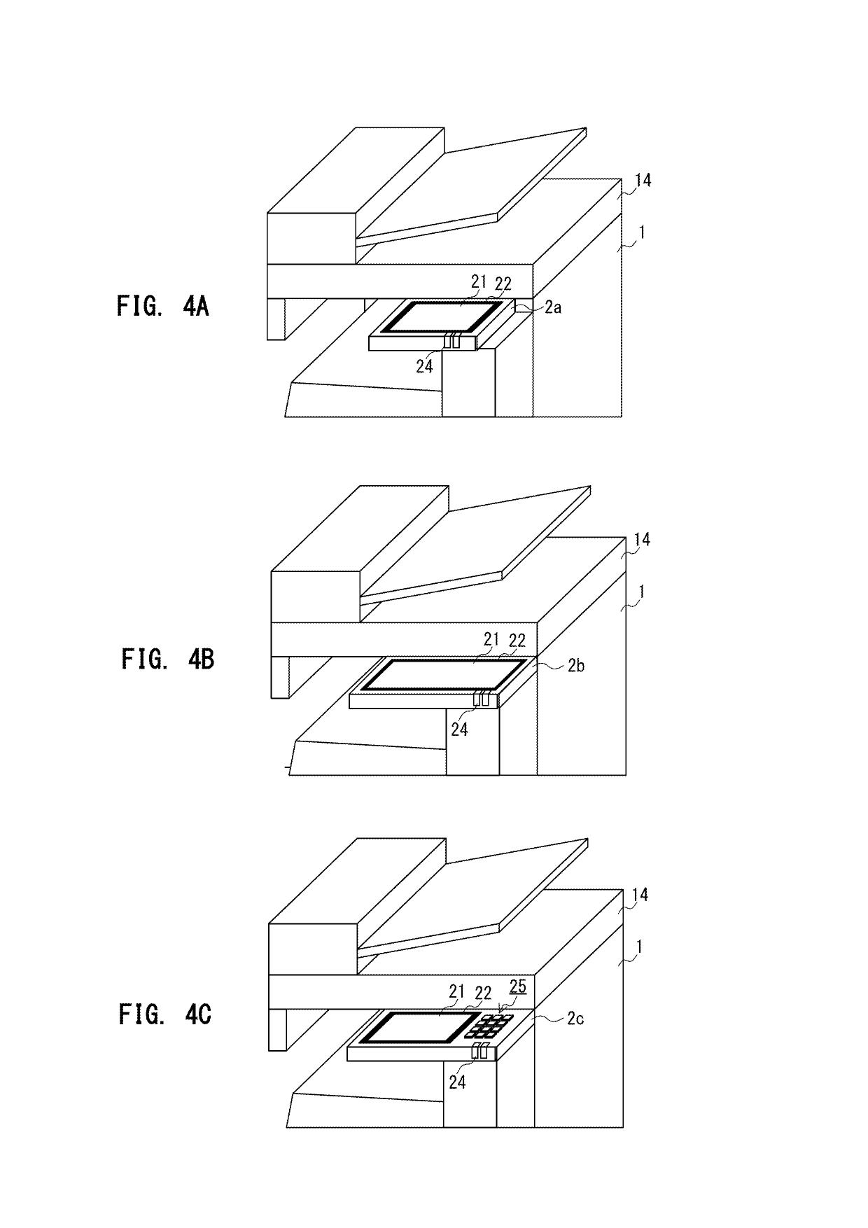

FIG. 4A to FIG. 4C are perspective views for illustrating a state in which the operation panel 2 is mounted on the main body of the image forming apparatus 1. The operation panel 2 is provided on the front side with respect to the reader 14 at an upper portion of the main body of the image forming apparatus 1. FIG. 4A shows a state in which the operation panel 2a is mounted. FIG. 4B shows a state in which the operation panel 2b is mounted. FIG. 4C shows a state in which the operation panel 2c is mounted.

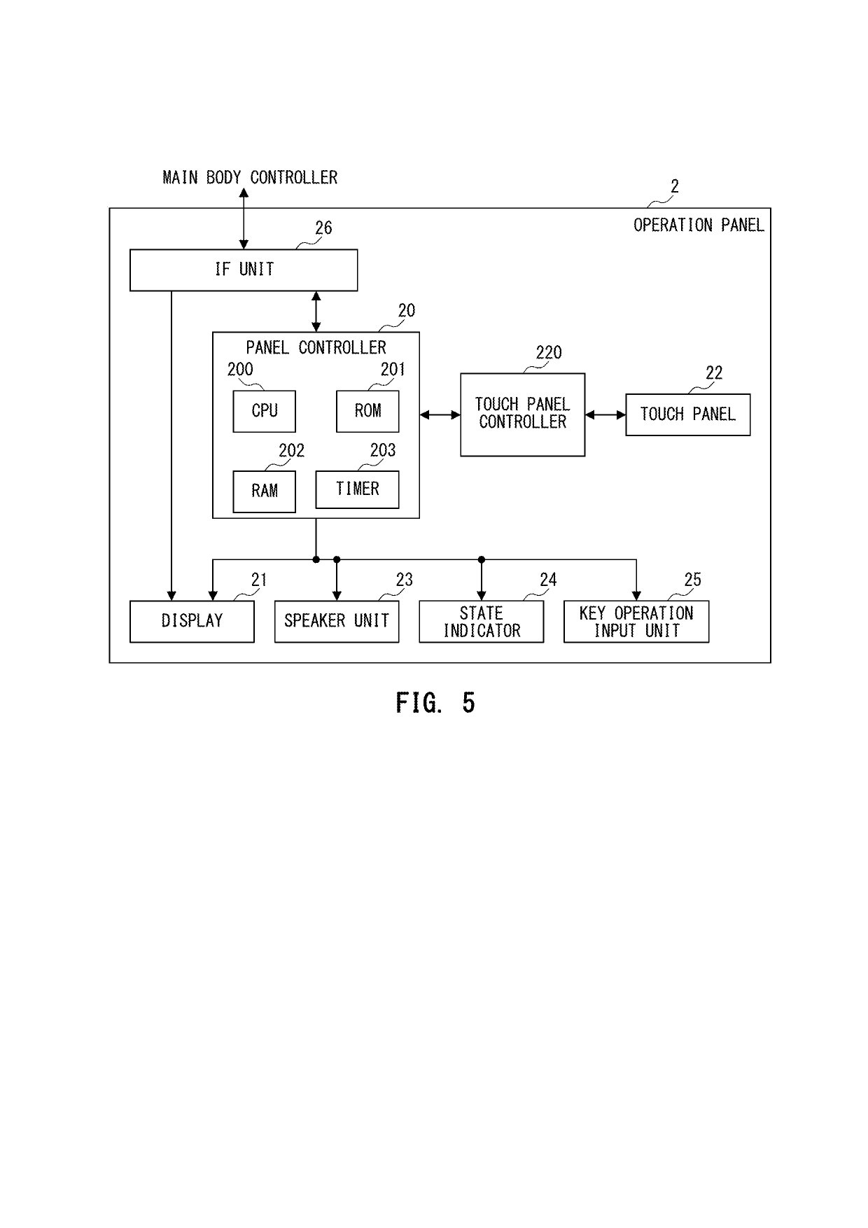

FIG. 5 is a system configuration diagram of the operation panel 2. The operation panel 2 includes a panel controller 20 including a CPU 200, a read only memory (ROM) 201, a random-access memory (RAM) 202, and a timer 203. The timer 203 is used for counting at the time of performing various types of processing by the panel controller 20. To the panel controller 20, a touch panel controller 220, an interface (IF) unit 26, the display 21, a speaker unit 23, the state indicator 24, and the key operation input unit 25 are connected. The IF unit 26 controls communication between the operation panel 2 and the main body controller 10. The panel controller 20 transmits input information received by the touch panel 22 to the main body controller 10 via the IF unit 26. Further, the panel controller 20 acquires an instruction from the main body controller 10 via the IF unit 26 to perform display of an image onto the display 21, output of a sound from the speaker unit 23, and lighting control of the state indicator 24. The touch panel 22 is connected to the touch panel controller 220.

The CPU 200 executes a control program stored in the ROM 201 to control the operation of the operation panel 2. The RAM 202 provides a work area used when the CPU 200 executes processing, and performs, for example, storage of temporal data. The CPU 200 executes the control program to control the touch panel controller 220, the IF unit 26, the display 21, the speaker unit 23, the state indicator 24, and the key operation input unit 25.

Further, the ROM 201 stores information relating to control. The ROM 201 stores, in addition to the control program of the operation panel 2, and the like, identification information of the operation panel 2 and information relating to connection to the image forming apparatus 1. Examples of the information relating to control include information indicating establishment of connection to the image forming apparatus 1 and information acquired from the image forming apparatus 1. Examples of the information acquired from the image forming apparatus 1 include information relating to the state of the image forming apparatus 1 such as a standby mode, a sleep mode, or error detection, and count information such as the number of printed sheets.

The display 21 is a display unit capable of displaying information stored in advance in the ROM 201 or information received from the main body controller 10. The CPU 200 can switch an image to be output to the display 21 between the image stored in the operation panel 2 (ROM 201) and the image acquired from the main body controller 10.

The touch panel controller 220 is controlled by the CPU 200 to control the operation of the touch panel 22. The touch panel 22 detects a position of the touch operation performed by the user. The speaker unit 23 is controlled by the CPU 200 to, for example, output a warning sound. The state indicator 24 turns on the lighting portion in accordance with a lighting request from the CPU 100 to give a notification that the image forming apparatus 1 is during job execution or an error has occurred.

### <Operation Panel Replacement>

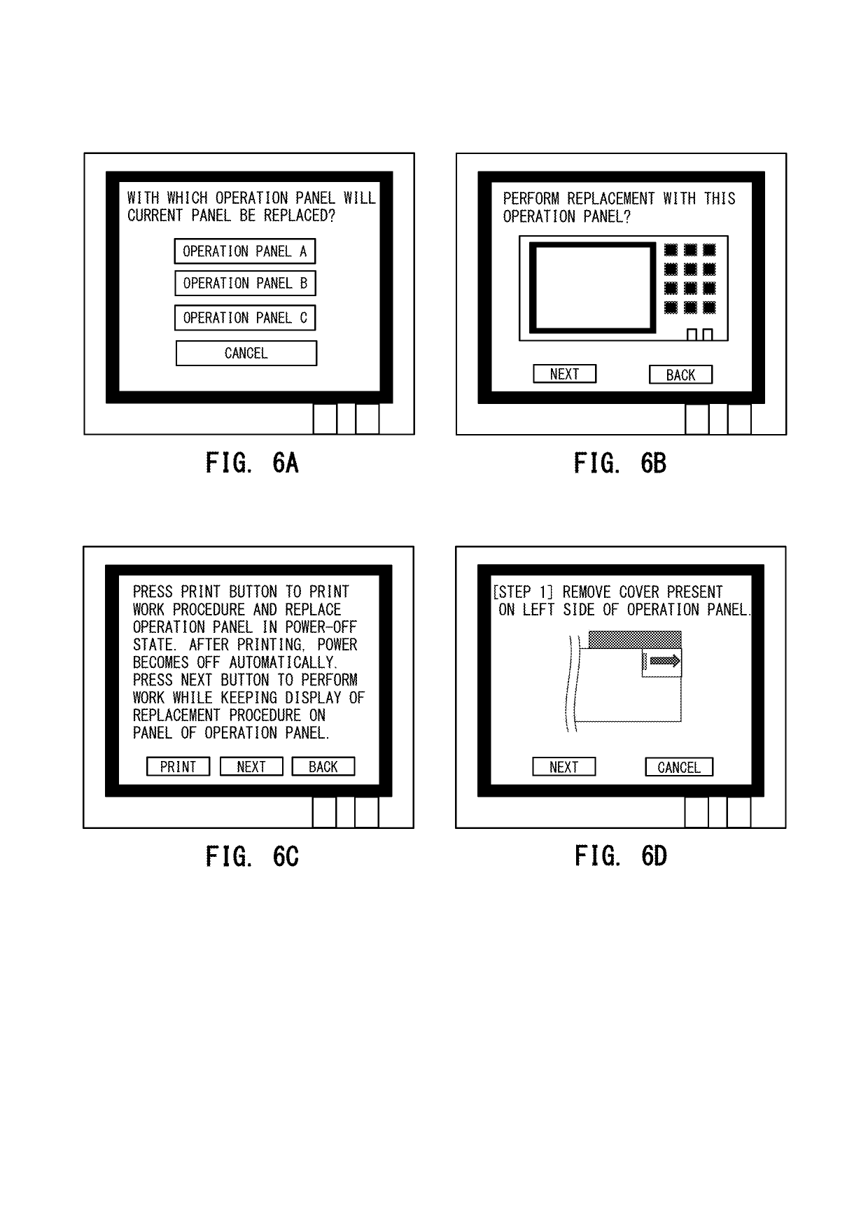

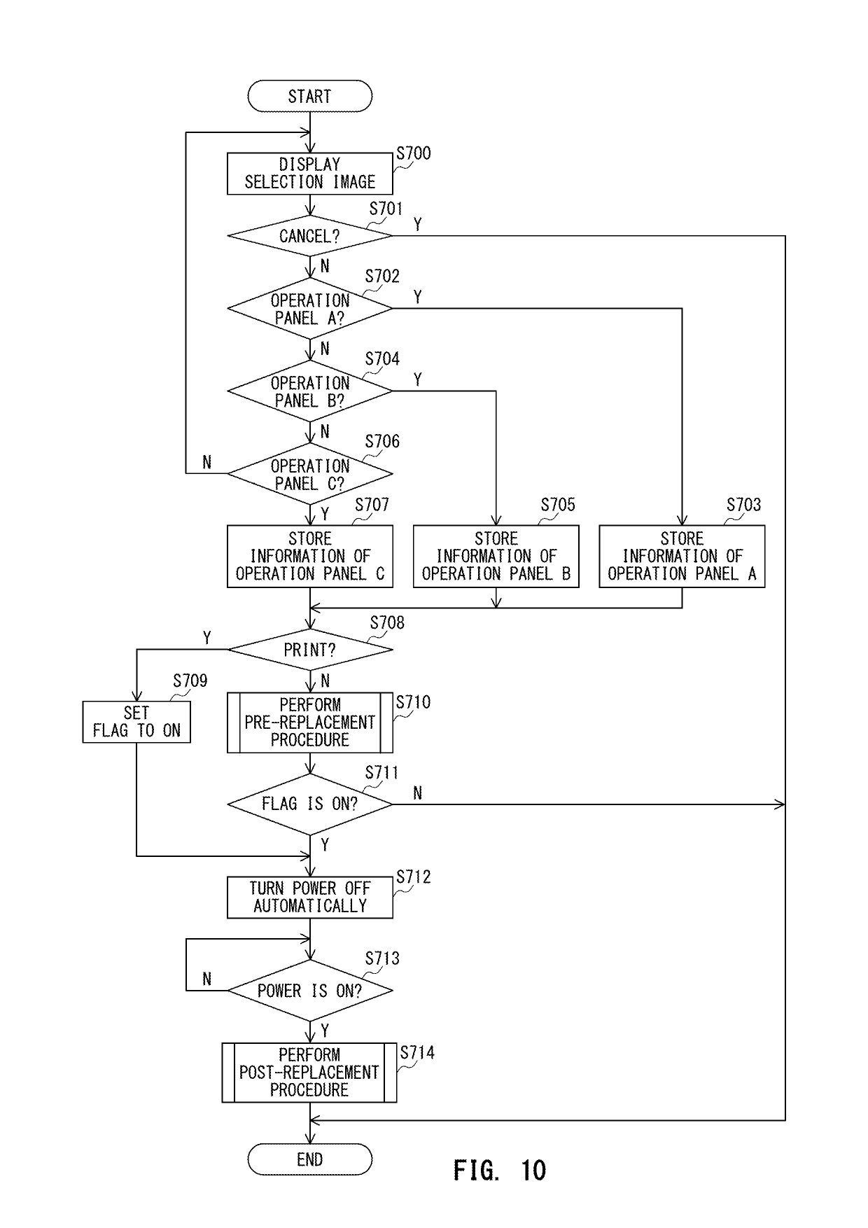

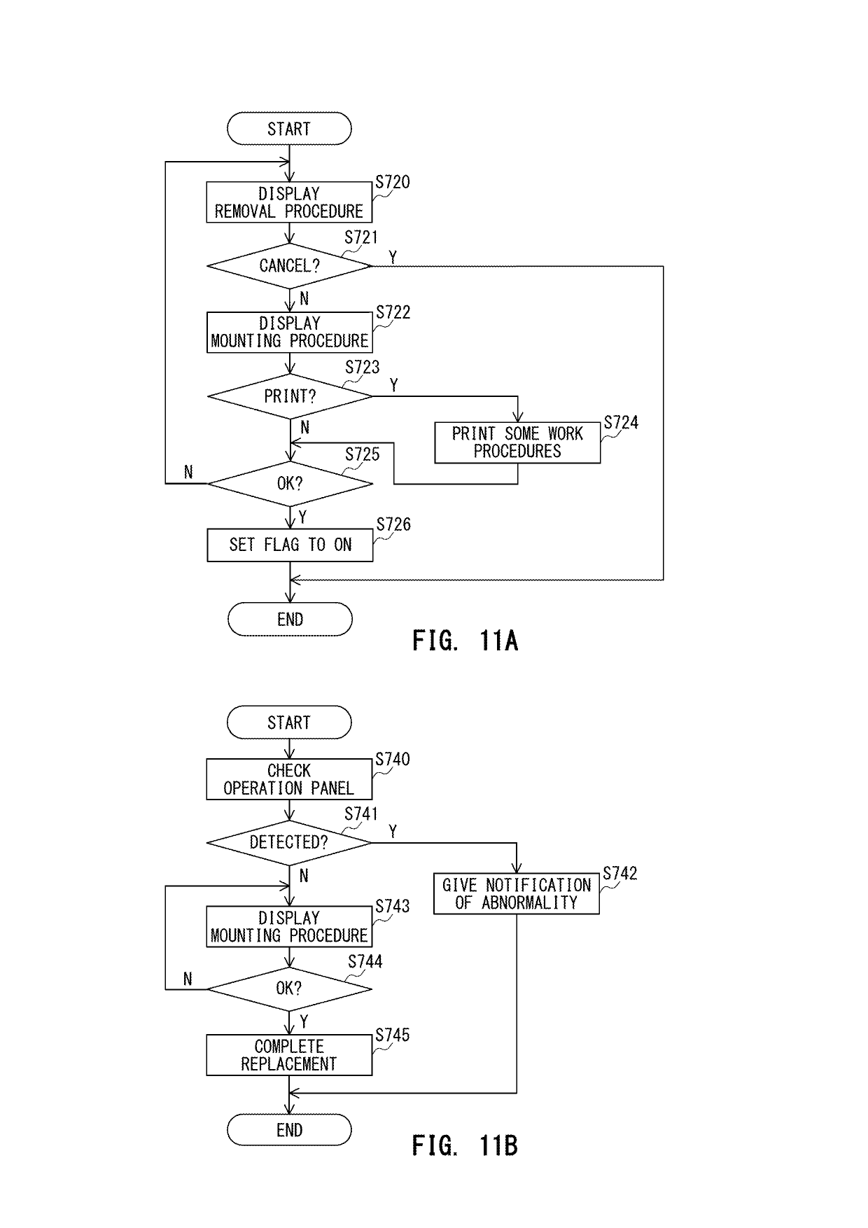

In the image forming apparatus 1 of the at least one embodiment, the operation panel 2 can be replaced. At the time of the work of replacing the operation panel 2, a procedure image of the replacement work is displayed on the display 21. FIG. 6A to FIG. 9D are exemplary views of the procedure images of the replacement work. FIG. 10, FIG. 11A, and FIG. 11B are flow charts for illustrating processing of displaying the procedure images of the work of replacing the operation panel 2. In this case, a procedure of replacing the operation panel 2a of FIG. 3A with the operation panel 2c of FIG. 3C is described. That is, the operation panel 2a is replaced from the state of FIG. 4A to achieve the state of FIG. 4C.

The user selects a button for starting the work of replacing the operation panel. The button is a software key displayed on the display 21, and is selected from a menu image that is an initial image. In this manner, the main body controller 10 starts the processing of displaying the procedure images of the work of replacing the operation panel 2.

The main body controller 10 displays a selection image of FIG. 6A on the display 21 of the operation panel 2a (Step S700). In the at least one embodiment, as the operation panel 2 that is mountable to the image forming apparatus 1, there are three types of operation panels, specifically, the operation panel 2a, the operation panel 2b, and the operation panel 2c. In the selection screen, buttons that allow those operation panels to be selected and a cancel button are displayed. On the selection screen, the operation panel 2a is displayed as an "operation panel A," the operation panel 2b is displayed as an "operation panel B," and the operation panel 2c is displayed as an "operation panel C."

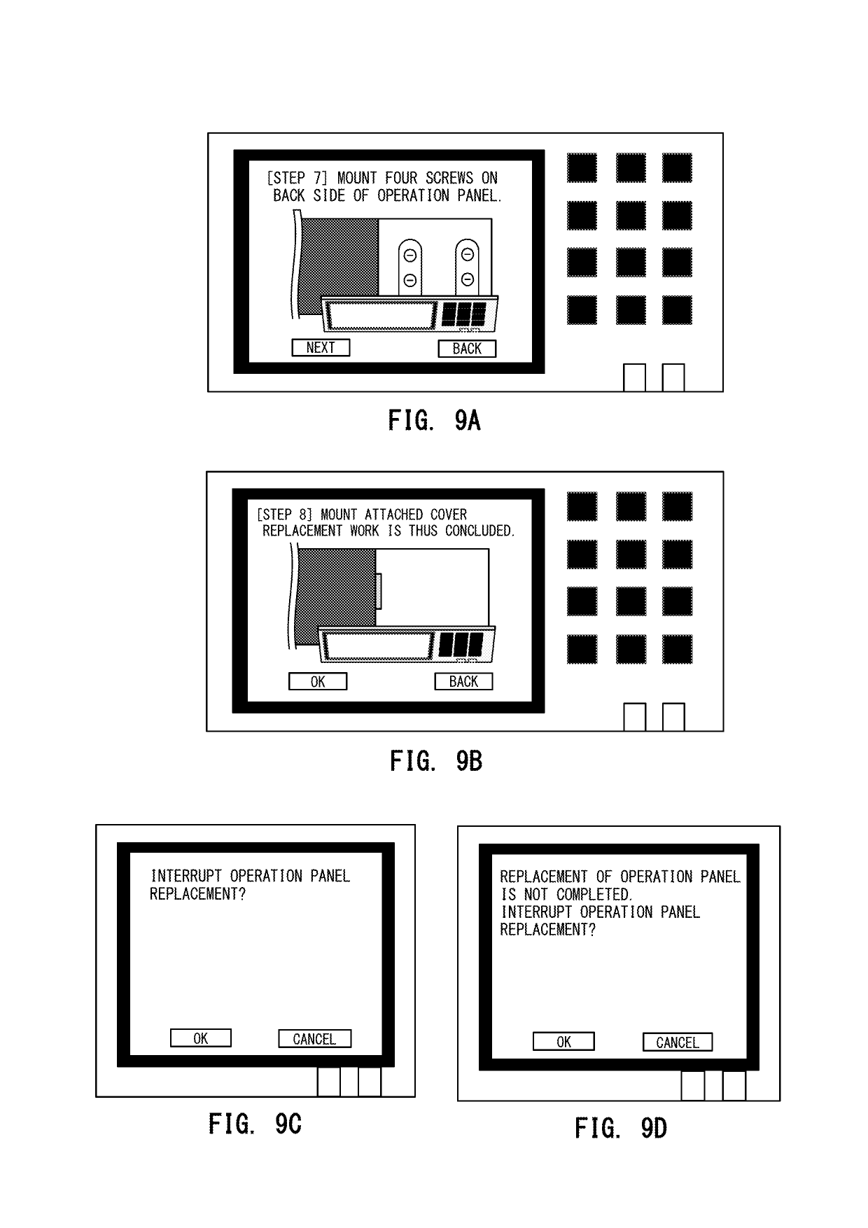

When the "cancel" button is selected (pressed) (Step S701: Y), the main body controller 10 displays an image of FIG. 9C on the display 21. When the user presses an "OK" button from the image of FIG. 9C, the work of replacing the operation panel is interrupted. When the user presses a "cancel" button from the image of FIG. 9C, the main body controller 10 displays the selection image of FIG. 6A again on the display 21.

When the button of the "operation panel A" is selected (pressed) from the selection image of FIG. 6A (Step S701: N, and Step S702: Y), the main body controller 10 stores, in the memory 101, the operation panel A as the information of the operation panel 2 being the replacement target (Step S703). When the button of the "operation panel B" is selected (pressed) (Step S701: N, Step S702: N, and Step S704: Y), the main body controller 10 stores, in the memory 101, the operation panel B as the information of the operation panel 2 being the replacement target (Step S705). When the button of the "operation panel C" is selected (pressed) (Step S701: N, Step S702: N, Step S704: N, and Step S706: Y), the main body controller 10 stores, in the memory 101, the operation panel C as the information of the operation panel 2 being the replacement target (Step S707). The selection image is displayed until any one of the "cancel" button, the button of the "operation panel A," the button of the "operation panel B," and the button of the "operation panel C" is selected (Step S701: N, Step S702: N, Step S704: N, and Step S706: N).

In the at least one embodiment, as described above, the operation panel 2a (operation panel A) is replaced with the operation panel 2c (operation panel C). Accordingly, in this case, the processing step of Step S707 is performed, and an image of FIG. 6B is displayed on the display 21. FIG. 6B is a confirmation image including a photograph of the operation panel C and being provided to prompt the user to check the operation panel after replacement. The user checks the operation panel after replacement through the confirmation image, and presses a "next" button. When a "back" button is pressed, the selection image of FIG. 6A is displayed on the display 21.

When the "next" button of the confirmation image is pressed, the main body controller 10 displays an image of FIG. 6C on the display 21 (Step S708). FIG. 6C is an instruction image for giving an instruction of whether or not to print a work procedure of the operation panel replacement. When a "print" button is pressed (Step S708: Y), the main body controller 10 prints all subsequent steps of the work procedure, and sets a replacement flag of the operation panel 2 to ON (Step S709). After that, the main body controller 10 turns off the power of the operation panel 2 automatically (Step S712). The power supply state at the time of power off is described later. When the "next" button is pressed (Step S708: N), the main body controller 10 displays the replacement procedure on the display 21. The main body controller 10 executes pre-replacement procedure processing (Step S710). When the "back" button is pressed, the confirmation image of FIG. 6B is displayed on the display 21.

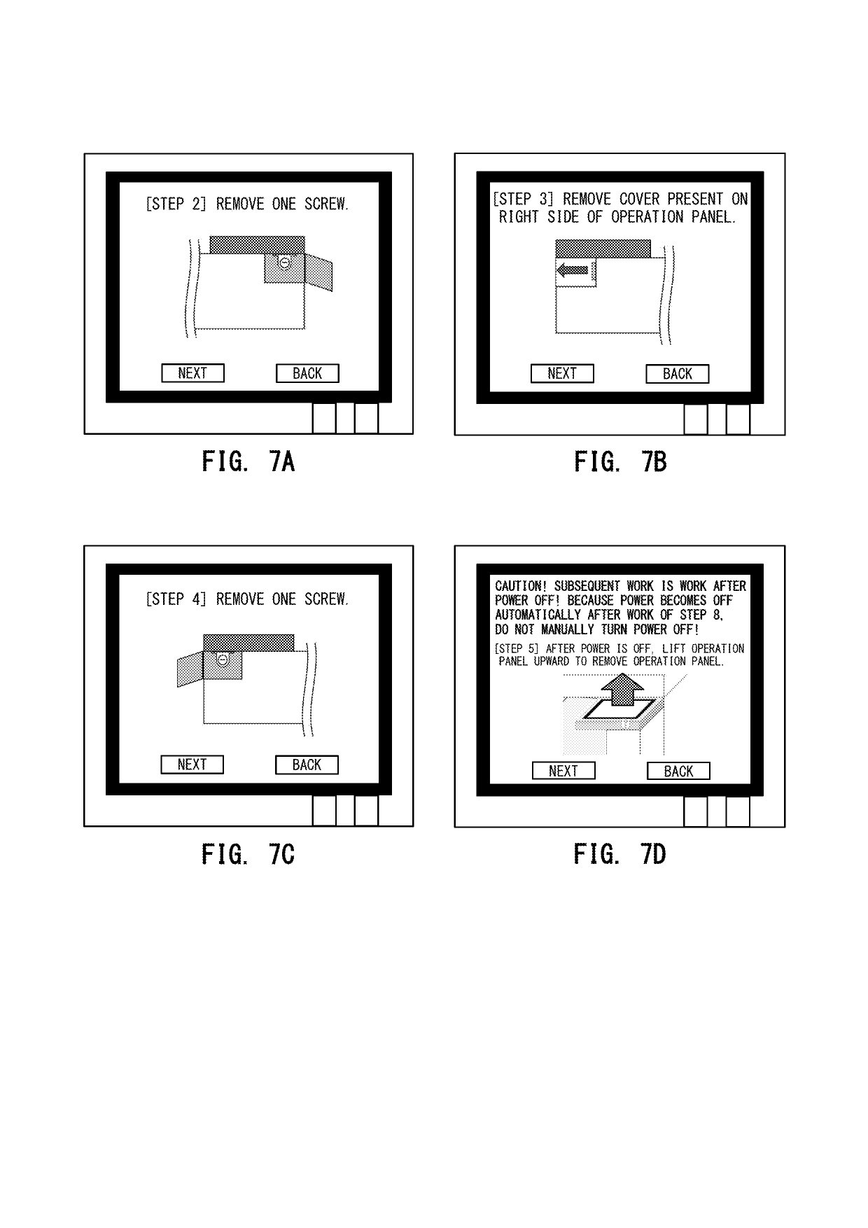

FIG. 11A is a flow chart for illustrating the pre-replacement procedure processing. In the pre-replacement procedure processing, the main body controller 10 sequentially displays images of FIG. 6D and FIG. 7A, FIG. 7B, and FIG. 7C on the display 21 to present a procedure of removing the operation panel 2a that is currently mounted (Step S720). The images of FIG. 6D and FIG. 7A, FIG. 7B, and FIG. 7C show steps of the procedure to be performed until the operation panel 2 is removed from the image forming apparatus 1 (step 1 to step 4). In the at least one embodiment, the operation panel 2a is mounted, and hence, in this case, a procedure of removing the operation panel 2a is displayed. When the operation panel 2b or 2c is mounted, a procedure of removing the operation panel 2b or 2c is displayed.

When the user presses the "cancel" button in the "step 1" of FIG. 6D (Step S721: Y), the main body controller 10 displays the image of FIG. 9C on the display 21. When the user presses the "OK" button from the image of FIG. 9C, the work of replacing the operation panel is interrupted. When the user presses the "cancel" button from the image of FIG. 9C, the main body controller 10 displays the image of FIG. 6D again on the display 21.

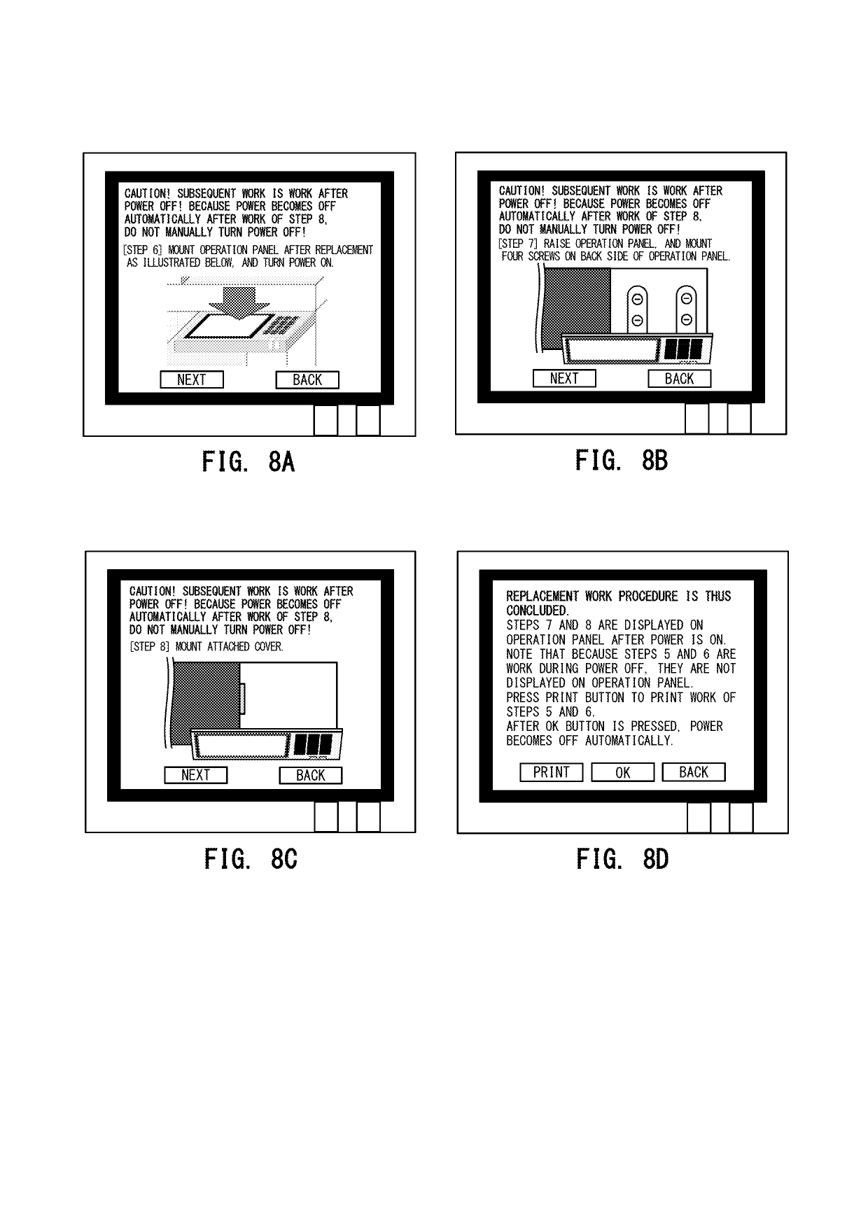

When the "cancel" button is not pressed in the "step 1" of FIG. 6D and the work progresses up to the step 4 presented in FIG. 7C (Step S721: N), the main body controller 10 displays an image of the step 5 of FIG. 7D on the display 21. In this manner, the procedure of removing the operation panel 2a is presented to the user. The work to be performed after the step 5 is work after power off, but after images of steps 6 to 8 are sequentially displayed on the display 21, power off is automatically executed by the main body controller 10. Accordingly, a comment to alert the user is displayed on the images presenting the steps 5 to 8. After that, the main body controller 10 sequentially displays the images of FIG. 8A to FIG. 8C on the display 21 to present the procedure of mounting the operation panel 2 by the steps 6 to 8 (Step S722). Here, the operation panel 2 that becomes a target of the mounting procedure is the operation panel selected in the selection image.

In the at least one embodiment, the operation panel 2c is the operation panel after replacement, and hence, in this case, a procedure of mounting the operation panel 2c is displayed. When the operation panel 2b is the replacement target, a procedure of mounting the operation panel 2b is displayed. Also in this case, similarly, an alert comment is displayed on the image.

After the images of the steps 6 to 8 are displayed, the main body controller 10 displays an image of FIG. 8D on the display 21. A confirmation message regarding whether or not to print the work procedure is displayed on the image of FIG. 8D because the steps 5 and 6 are work during power off (Step S723). When the "print" button is pressed (Step S723: Y), the main body controller 10 performs printing of some steps of the procedure (in this case, the steps 5 and 6) (Step S724). When the "back" button is pressed (Step S725: N), the main body controller 10 returns the process to Step S720. When the "OK" button is pressed (Step S723: N, and Step S725: Y), the main body controller 10 sets the replacement flag of the operation panel 2 to ON (Step S726). In this manner, the pre-replacement procedure processing is ended.

After the pre-replacement procedure processing is ended, the main body controller 10 checks whether or not the replacement flag of the operation panel 2 is set to ON (Step S711). When the replacement flag is not set to ON (Step S711: N), the main body controller 10 determines that the replacement of the operation panel 2 has been interrupted, and ends the processing. When the replacement flag is set to ON (Step S711: Y), the main body controller 10 turns off the power of the operation panel 2 automatically (Step S712). The power supply state at the time of power off is described later.

The user performs the work of the steps 5 and 6 described above after the power off. That is, the operation panel 2 is replaced. In the at least one embodiment, the operation panel A (operation panel 2a) is removed from the image forming apparatus 1, and the operation panel C (operation panel 2c) is newly mounted. After the steps 5 and 6, the main body controller 10 turns on the power of the operation panel 2 automatically (Step S713: Y). When the power is turned on, the main body controller 10 executes post-replacement procedure processing of the operation panel 2 (Step S714). In FIG. 9A and FIG. 9B, the steps 7 and 8 after the step 6 are displayed, and hence the mounted operation panel 2 is the operation panel C (operation panel 2c).

FIG. 11B is a flow chart for illustrating the post-replacement procedure processing. The main body controller 10 checks the information of the operation panel that is currently connected (Step S740). The main body controller 10 detects occurrence of an abnormality by checking whether or not the information of the operation panel checked in the processing step of Step S740 and the information of the operation panel 2 being the replacement target stored in the memory 101 match each other (Step S741). The main body controller 10 performs the processing step of Step S741 by checking, for example, identification information allocated to the operation panel. The main body controller 10 acquires, for example, the identification information from the ROM 201 of the panel controller 20 to detect the occurrence of the abnormality based on whether or not the acquired identification information is the same as the identification information stored in the memory 101. In the memory 101, the identification information is stored in the processing steps of Step S703, Step S705, or Step S707. In the ROM 201, the identification information of the mounted operation panel 2 is stored.

When no operation panel 2 is connected or when replacement with a wrong operation panel is performed, the information of the operation panel checked in the processing step of Step S740 and the information of the operation panel 2 being the replacement target stored in the memory 101 do not match with each other, and an abnormality is detected. In this case (Step S741: Y), the main body controller 10 notifies the user of the abnormality, and ends the processing (Step S742). FIG. 9D is an exemplary view of a notification image to be displayed on the display 21 at the time of notification of the abnormality. FIG. 9D shows a notification image in a case in which replacement with a wrong operation panel is performed. When no operation panel 2 is connected, the main body controller 10 uses, for example, the notification unit 17 of FIG. 2 to notify the user of the abnormality.

When no abnormality is detected (Step S741: N), the main body controller 10 sequentially displays the images of FIG. 9A and FIG. 9B on the display 21 of the operation panel C to present the steps 7 and 8 for mounting the operation panel C (Step S743). When the user presses the "OK" button of the image of FIG. 9B after the step 8 is completed (Step S744: Y), the post-replacement procedure processing of the operation panel 2 is completed (Step S745). In this manner, the processing steps of FIG. 10 are also ended.

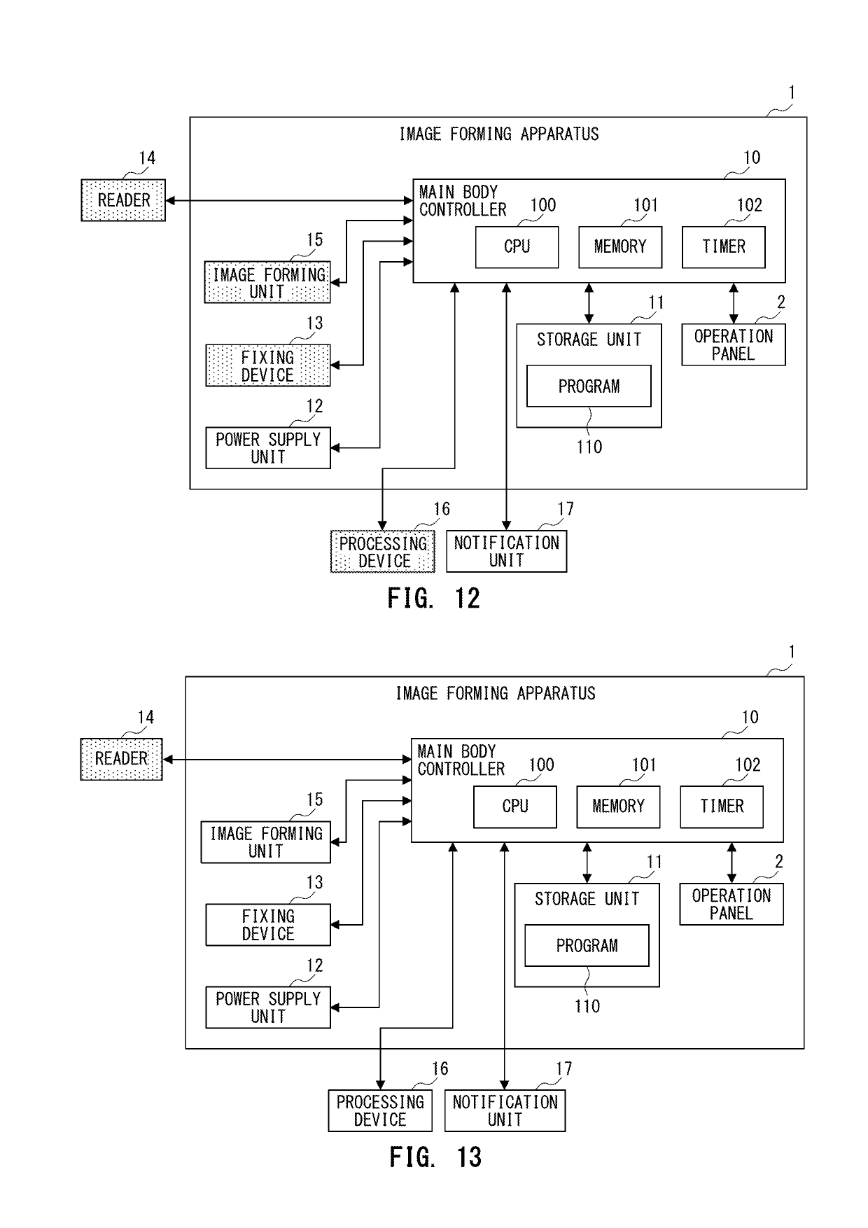

An example of the power supply state of the image forming apparatus 1 at the time of the work of replacing the operation panel 2 is described. FIG. 12 to FIG. 14 are explanatory views of the power supply state. In FIG. 12 to FIG. 14, the shaded part is a section in which power supply is interrupted.

FIG. 12 is an explanatory view of the power supply state during the work of replacing the operation panel 2. In this case, the scanning operation by the reader 14 and the image forming operation by the image forming unit 15, the fixing device 13, and the processing device 16 are unrequired. Accordingly, the power supply to the reader 14, the image forming unit 15, the fixing device 13, and the processing device 16 can be interrupted. Meanwhile, even at the time of the work of replacing the operation panel 2, the operation panel 2, the main body controller 10, the power supply unit 12, the storage unit 11, and the notification unit 17 are in the power supply state. The main body controller 10 controls the operation panel 2. The power supply unit 12 causes the main body controller 10 to operate. The notification unit 17 is used when an abnormality has occurred. However, when the "print" button is pressed in order to print the work procedure in FIG. 6C or FIG. 8D, as illustrated in FIG. 13, the image forming unit 15, the fixing device 13, and the processing device 16 are brought into the power supply state.

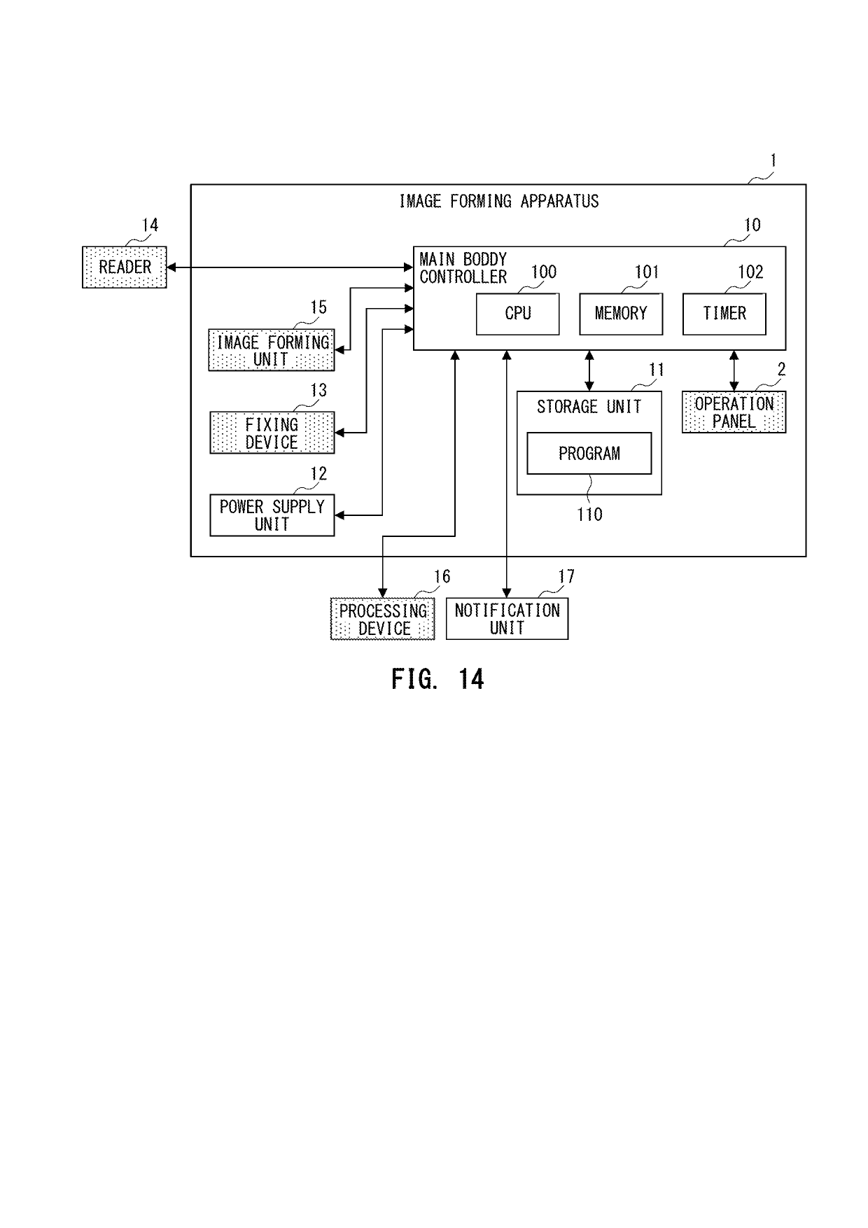

Further, during a power-off period of FIG. 7D to FIG. 8A, it is only required to interrupt the power supply to the operation panel 2. Accordingly, as illustrated in FIG. 14, interruption of the power supply to the operation panel 2 is added to FIG. 12.

In the at least one embodiment as described above, the work procedure of removing the operation panel 2 mounted on the image forming apparatus 1 and the work procedure of mounting the operation panel 2 after replacement are displayed on the display 21 of the operation panel 2. Accordingly, the user can easily perform the work of replacing the operation panel 2.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-227526, filed December 24, 2024, which is hereby incorporated by reference herein in its entirety.

What is claimed is:

1. An image forming apparatus for printing an image on a sheet, the image forming apparatus comprising an operation panel which includes a display and which is mounted in a replaceable manner on a main body,
wherein the display is configured to display a work procedure for replacement of the operation panel.

2. The image forming apparatus according to claim 1,
wherein, on the image forming apparatus, one of a plurality of types of operation panels is mounted in a replaceable manner,
wherein the display is configured to display a selection image for selecting an operation panel after replacement from the plurality of types of operation panels, and
wherein the operation panel that is currently mounted on the main body is configured to receive a user selection of the operation panel for replacement via the selection image.

3. The image forming apparatus according to claim 2, wherein the image forming apparatus is configured to print a procedure of replacement with the selected operation panel.

4. The image forming apparatus according to claim 2, wherein the display is configured to display a procedure of replacement with the selected operation panel.

5. The image forming apparatus according to claim 4, wherein the display is configured to display an image representing a procedure of removing the operation panel that is currently mounted, and display an image representing a procedure of mounting the selected operation panel.

6. The image forming apparatus according to claim 5, wherein the image forming apparatus is configured to print the image representing the procedure of mounting the selected operation panel.

7. The image forming apparatus according to claim 6, wherein the image representing the procedure of mounting the selected operation panel includes an image for giving an instruction of work to be performed while power of the operation panel is off.

8. The image forming apparatus according to claim 2, wherein the operation panel includes a notification unit configured to give a notification of an abnormality when replacement with an operation panel different from the selected operation panel is performed.

9. The image forming apparatus according to claim 8, wherein the abnormality is detected based on identification information of the operation panel selected from the selection image and identification information of the operation panel after the replacement.
